(19) United States
(12) Patent Application Publication
(10) Pub. No.: US 2012/0133485 A1
(43) Pub. Date: May 31, 2012

(54) Wireless Gate Control and Communication System

(75) Inventor: Shary Nassimi, Malibu, CA (US)

(73) Assignee: THE CHAMBERLAIN GROUP, INC., Elmhurst, IL (US)

(21) Appl. No.: 13/364,872

(22) Filed: Feb. 2, 2012

Related U.S. Application Data
(63) Continuation of application No. 11/685,466, filed on Mar. 13, 2007.
(60) Provisional application No. 60/767,285, filed on Mar. 15, 2006.

(51) Int. Cl. G08B 29/00

(52) U.S. Cl. 340/5.54; 340/5.61; 340/5.51

(57) ABSTRACT

A gate control and communication system of the invention including a base unit located within a premises, a gate receiver unit positioned next to a remotely located gate, and a gate control unit located next to the gate. The base unit provides for voice communications with an individual at the gate and for issuing of commands to control the gate. The gate receiver unit includes a switching device which, in response to commands directs the opening and closing of the gate. The gate control unit includes a call button for initiating voice communication with the base unit and a keypad for entering an identification code or password. The information stored in an existing gate control unit may be cloned into an additional or replacement gate control unit by entering an appropriate identification code and command while positioning the units in range of each other.

### CROSS-REFERENCE TO RELATED APPLICATION

This application is a continuation of U.S. patent application Ser. No. 11/685,466, filed on Mar. 13, 2007, which application claims the benefit of U.S. Provisional Application No. 60/767,285, filed Mar. 15, 2006, each of which is incorporated by reference in its entirety herein.

This application is also related to U.S. patent application Ser. No. 11/685,470, filed on May 23, 2007, now abandoned, which is incorporated by reference in its entirety herein

### FIELD OF THE INVENTION

The present invention relates to control of access to secured locations, as when a door or gate is positioned to block entry to a residential or business premises and is opened or released in response to a coded input, in association with a system providing communication between the vicinity of the gate and the premises.

### DESCRIPTION OF THE RELATED ART

Physical access to many residential and commercial premises is controlled by placing a movable barrier such as a gate or door in a fence or wall and installing a control system to unlock and/or physically move the barrier to an open position, permitting access to the secured premises, in response to an electrical signal. This input signal may be generated in response to a coded input entered on a keypad adjacent the barrier for those authorized users who are provided with the code, or in response to an input, e.g., entering the code or simply pressing a push-button, at the premises by a person wishing to provide access to a visitor at the barrier who has been identified through a communication system linking the barrier and the premises. The barrier may be tens or hundreds of feet from the premises. For purposes of the present discussion, it will be assumed that the movable barrier is a gate, although it will be understood that such term is to include doors and other such barriers.

The gate is moved between open and closed positions by an electric motor. A keypad, or other such input device, is installed on or near the gate and also requires electrical power, as does the system providing communication between the gate and premises. Although some access control systems employ solar power, this may not always be reliable and the usual practice is to connect the gate motor controller, keypad and communication system to a power source at the premises, often requiring expensive trenching over relatively long distances. Also, the communications system requires connection between the gate and the telephone system of the premises to allow visitors to call from the gate area. A separate telephone line may be required for the communication system to operate properly. If the phone line connecting the gate and premises is subject to being used at the premises for calls other than those from the gate, provision must be made for interrupting the use at the premises in order to ensure that the call from the gate is acknowledged promptly.

### BRIEF SUMMARY OF THE INVENTION

It is therefore a principal object and advantage of the present invention to provide a gate control and communication system which is wire-free.

Another object is to provide a gate control and communications system for use in access control devices which has extremely low power requirements, permitting practical operation with standard or solar rechargeable batteries.

A further object is to provide an access control system including a gate control unit and communications system which offers a full range of functionality, is extremely reliable and, at the same time, lower in cost than comparable prior art systems.

Other objects will in part be obvious and will in part appear hereinafter.

In accordance with the foregoing objects and advantages, the present invention provides a three-part system, namely, a base unit, a gate receiver unit and a gate control unit, the latter being hereinafter referred to as a GCU. The base unit is located at or within the premises and comprises a transceiver designed to interface with the other two parts. That is, the base unit permits an individual at the premises to respond to a call from the GCU, provides two-way voice communication between the premises and the GCU, and permits command signals to be communicated from the premises to the GCU to open the gate.

The gate receiver unit comprises an output switching device such as a relay or a similar semiconductor device that will command the gate operator to open the gate when a valid signal and command is received from the GCU or base unit. The GCU is located in the gate area and features an ultra low power microprocessor which controls the functionality of the system. Additional components of the GCU are a transceiver section with high efficiency and low power consumption, but with enough power output to reach the premises (base unit) reliably, a battery power system comprised of standard, non-rechargeable batteries or rechargeable batteries with a solar charger, a microphone, a speaker, means for converting audio signals from the microphone to RF signals for transmission to the base unit, means for converting incoming RF signals to signals which provide audible output on the speaker, and means for compressing the sampled audio data stream to a much smaller than standard audio spectrum and limited to speech quality sound. The transceiver unit transmits and receives signal at very high speed, whereby the time required for playback of signals in real time is much longer than the time required for transmission and reception of the data stream. Additionally, a low duty cycle allows the microprocessor to turn the transceiver off except when actually operating to send or receive signals.

The construction and operation of the invention will be more readily understood and fully appreciated from the following detailed disclosure, taken in conjunction with the accompanying drawings.

### BRIEF DESCRIPTION OF THE DRAWINGS

The present invention will be more fully understood and appreciated by reading the following Detailed Description in conjunction with the accompanying drawings, in which:

FIG. 1 is diagrammatic showing of a gated premises equipped with the control and communication system of the present invention;

FIGS. 2A and 2B are somewhat diagrammatic illustration of two versions (stationary and portable) of one of the units making up the system of the invention;

FIG. 3 is a schematic illustration of the individual components of the unit of FIGS. 2A and 2B;

FIG. 4 is a flow chart showing the sequence of operation of the unit of FIGS. 2A, 2B and 3;

FIG. 5 is a somewhat diagrammatic illustration of a second of the units making up the system of the invention;

FIG. 6 is a schematic illustration of the components of the unit of FIG. 5;

FIG. 7 is a flow chart showing the sequence of operation of the unit of FIGS. 5 and 6;

FIG. 8 is a somewhat diagrammatic illustration of the third of the units making up the system of the invention;

FIG. 9 is a schematic illustration of the components of the unit of FIG. 8; and

FIG. 10 is a flow chart showing the sequence of operation of the unit of FIGS. 8 and 9;

FIG. 11 is a flowchart showing one example of the cloning process.

### DETAILED DESCRIPTION OF THE PREFERRED EMBODIMENT

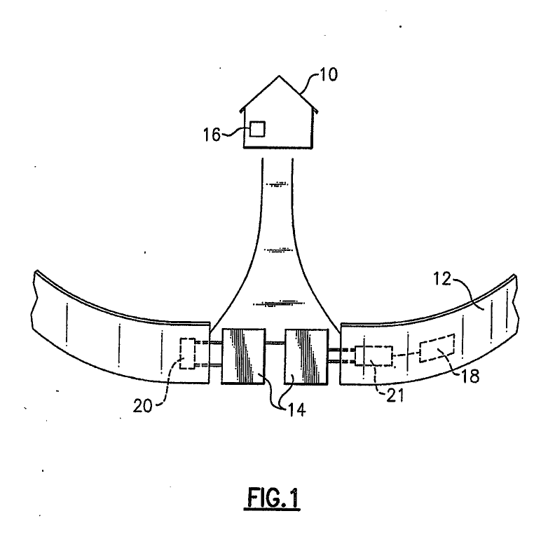

Referring now to the drawings, wherein like reference numerals refer to like parts throughout, there is seen in FIG. 1 a residential or commercial building 10, herein referred to as a premises, surrounded entirely or partially by a fence or wall 12 at some distance from premises 10. A movable barrier, such as gate 14, is movable between unblocking and blocking (open and closed, respectively) positions with respect to an opening in wall 12. Boxes 16, 18 and 20 indicate three units making up the system of the invention, namely a base unit 16, a gate receiver unit 18 and a gate control unit 20, respectively, each separately described in some detail hereinafter. Box 21 represents a gate operating device, such as an electric motor, for physically moving gate 14 between its open and closed positions.

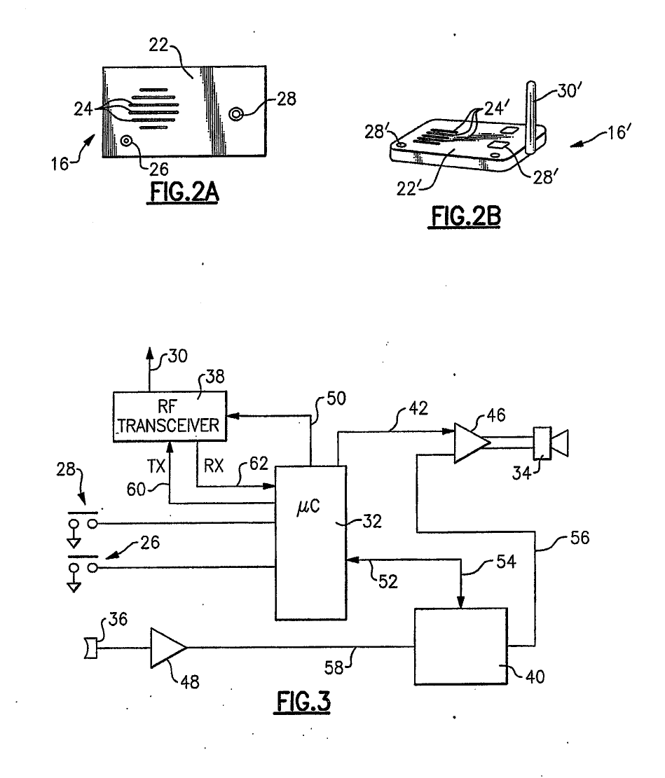

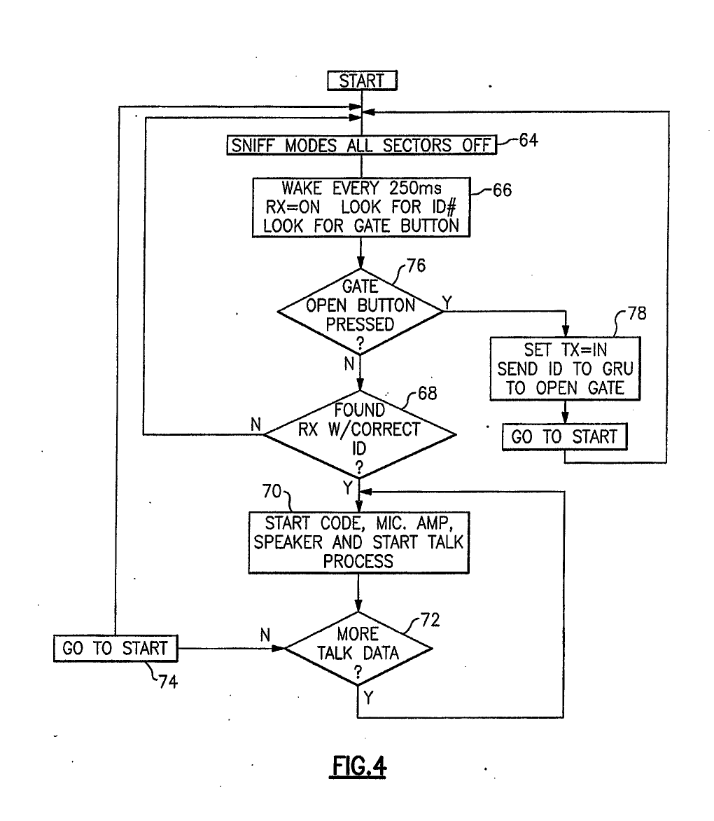

Base unit 16 is shown in FIG. 2A as it might appear in a stationary mounting at premises 10. Plastic or metal face plate 22 is flush mounted to a wall of premises 10 and includes a plurality of openings 24 positioned in front of a speaker (described later). Volume control knob 26 and command button 28 are also positioned on the forward side of plate 22. The same components are present in the portable device 16′ of FIG. 2B, namely face plate or housing 22′, speaker openings 24′, volume control knob 26′ and command button 28′. Also seen in FIG. 2B is antenna 30; antenna 30 of base unit 16 is seen in FIG. 3.

The individual components of base unit 16 are shown schematically in FIG. 3. Microprocessor 32 is a conventional component chosen for ultra low power consumption and ability to provide the required functions in controlling the functionality of base unit 16. Appropriate pins of microprocessor 32 are connected to volume control 26, command button 28, speaker 34, microphone 36, RF transceiver 38 and codec 40. Power control lines 42 and 44 connect microprocessor 32 to amplifier 46 of the speaker and preamp/filter 48 of the microphone, respectively, while power control lines 50 and 52 connect microprocessor 32 to transceiver 38 and codec 40, respectively. Data input/output signals pass between microprocessor 32 and codec 40 via line 54, and the signals are passed from codec 40 to the input amplifiers of speaker 34 and microphone 36 via lines 56 and 58, respectively. Signals for transmission by RF transceiver 38 are fed from microprocessor 32 via line 60 and signals which have been received by the transceiver are communicated to the microprocessor via line 62. Codec 40 is a conventional device for compressing and decompressing data, and may be implemented in software, hardware, or a combination of both.

FIG. 4 provides a flow chart of base unit functions. After operation starts, the base unit constantly monitors the on/off condition of all sections, as indicated by box 64. Power to all sections is normally turned off until initiation of an event which requires power, such as transmission or reception of data by transceiver 38, whereupon base unit 16 “wakes” the power supply to the various sections of the system and the base unit looks for signals representing an ID code entered at the GCU and for the condition of the gate control button, as indicated by box 66. If received data does not indicate entry of a correct ID on the GCU keypad (described later), as indicated by box 68, the system returns to the start condition. If the received signal indicates entry of a proper ID, codec 40, speaker 34 and microphone 36 are started (powered), and the talk process (interchange of data) is started, as indicated by box 70. Box 72 indicates the function of monitoring when talk data ends, in which case the system is returned to the start condition, as indicated by box 74, or when talk data continues, in which case the box 70 functions continue. Box 76 indicates the function of sensing whether the gate open button is or is not pressed; if affirmative, signals are transmitted indicating a proper ID and causing the gate receiver unit to open the gate (box 78), whereupon the functions revert to start.

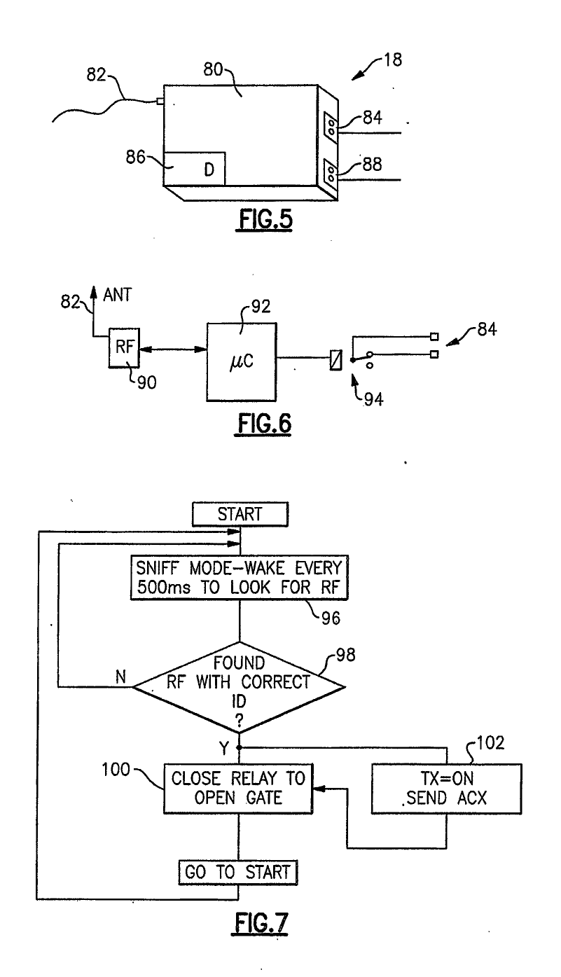

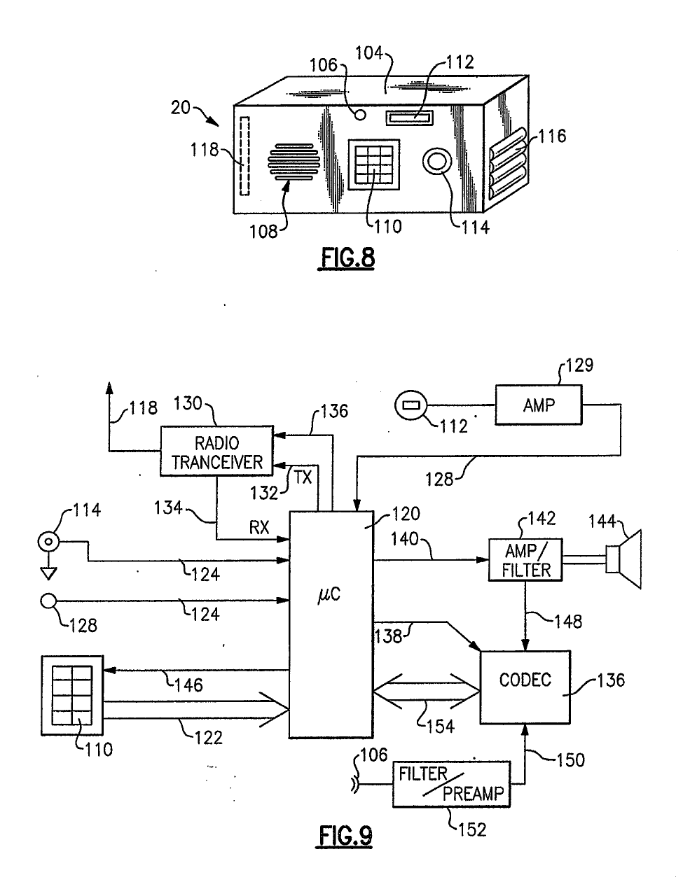

Gate receiver unit 18 is shown in FIG. 5 and includes housing 80, antenna 82, relay output receptacle 84, battery compartment 86 and optional plug-in power receptacle 88. That is, unit 18 may be powered either by batteries or by power from the gate control system. The elements within housing 80, shown schematically in FIG. 6, include RF receiver 90, microprocessor 92 and an output switching device such as relay 94, connected to relay output 84. RF receiver 90 is in the “off” condition, i.e., is consuming no power, except for brief (e.g., 500 ms) intervals to respond and send a signal to microprocessor 92 when a signal is received from base unit 16 or gate control unit 20. If microprocessor 92 identifies the signal as proper and valid, relay 94 is actuated to command the gate operator to open the gate 14.

A flow chart showing the functions of gate receiver unit 8 is shown in FIG. 7. After system start, RF receiver 90 remains in “sniff” mode, i.e., the receiver is powered only at brief, spaced intervals to monitor RF signals received from base unit 18 or gate control unit 20, as indicated by box 96. Microprocessor 92 checks signals from receiver 90, as indicated by block 98, for correct ID. When no valid signal is detected, the system reverts to start, and when a signal with correct ID is indicated, relay 94 is actuated, as indicated by box 100 to open gate 14. Box 102 indicates an optional function, namely, transmitting of a signal acknowledging receipt of the command signal from base unit 16 or gate control unit 20; this requires, of course, that receiver 90 also include transmission capability.

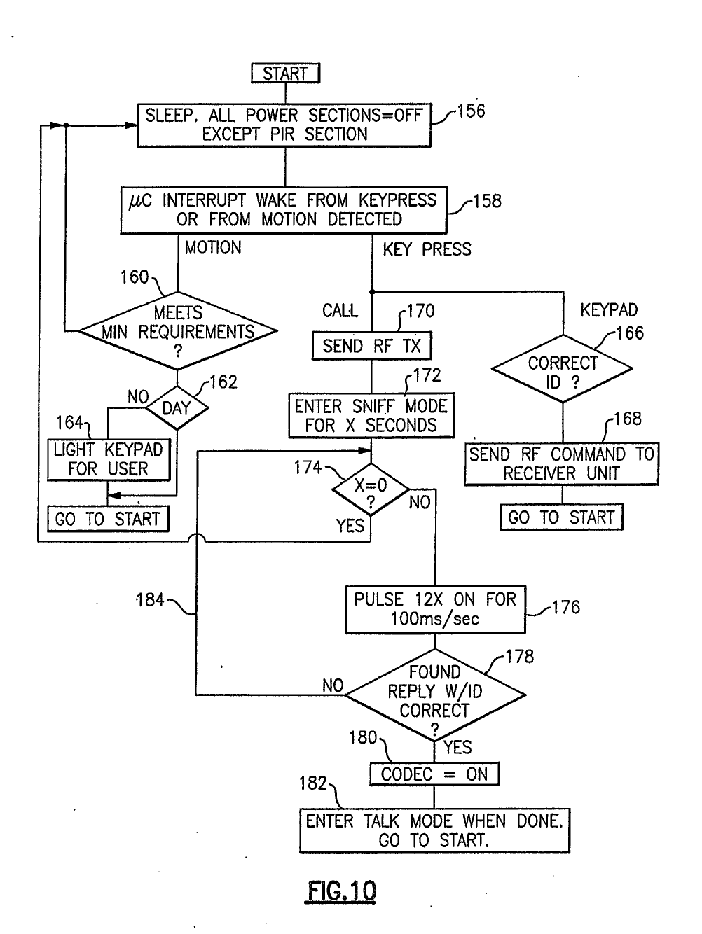

A physical example of gate control unit 20 is shown in FIG. 8 and includes housing 104, microphone 106, speaker outlet 108, keypad 110, motion sensor 112, call button 114, batteries 116 and antenna 118. These items are shown schematically in FIG. 9, together with other components of the gate control unit. Microprocessor 120 receives signals on lines 122, 124 and 126 from keypad 110, day/night detector 128 (through amplifier 129) and motion detector 112, respectively. Signals for transmission by RF transceiver 130 are communicated from microprocessor 120 via line 132 and signals received by the transceiver are communicated to the microprocessor via line 134. Power control for transceiver 130 and codec 136 is provided via lines 136 and 138, respectively, and power control is provided via line 140 to amp/filter 142 of speaker 144, positioned in housing 104 behind outlets 108. Line 146 provides a lighting control signal for keypad 110 in accordance with signals provided to microprocessor 120 from day/night detector 128. Codec 136 receives signals on lines 148 and 150 from amp/filter 142 of speaker 144 and from filter/preamp 152 of microphone 106, respectively, and performs the same functions with respect to these signals as codec 40 of base unit 16 (FIG. 3). Input/output signals are exchanged between microprocessor 120 and codec 136 via line 154.

FIG. 10 is a flow chart of the functions of gate control unit 20. At system start, power is provided only for operation of motion detector 112, as indicated by box 156. Pressing call button 114 or any key on keypad 110, or detection of motion by detector 112 activates microprocessor 120 (box 158). If activation is due to detected motion, the system determines if the level of motion meets minimum requirements for motion activation (160). If not, the system returns to start; if so, detector 128 determines light conditions (162) and, if illumination is required, keypad 110 is lighted for a predetermined period (164), following which the motion detection system returns to start.

If activation is due to a key press, and such key press is of a sequence of keys on keypad 110, the system determines whether the sequence conforms to a predetermined ID (166); if so, an RF command is sent to gate receiver unit 18 (168), gate 14 is opened and the gate control unit returns to start. If activation is due to pressing call button 114, an RF transmission is initiated (170) and power is provided for the system to monitor (“sniff”) for a reply, as indicated by box 172, for a predetermined time. Upon expiration of the time period (174), i.e., upon counting down to zero with no reply, the system reverts to start. If a reply is received before expiration of the time period, transceiver 130 is pulsed to receive RF signals for 100 milliseconds/sec (176). The system then checks the reply for correct ID (178) and, if a correct ID is detected, codec 136 is activated, as indicated by box 180, to compress and expand the RF signals as the system enters talk mode and, when voice communication is finished, returns to start (182). If correct ID is not indicated, the system reverts to monitoring for a reply (line 184).

In summary, the gate control and communication system of the invention includes three units, namely, a base unit located within the premises to which access is controlled, a gate receiver unit located in the vicinity of the gate and a gate control unit also located for access by an individual in the vicinity of the gate. The base unit allows an occupant of the premises to carry on 2-way voice communications with an individual at or near the gate and to issue commands to open the gate. The gate receiver unit includes a switching device such as a relay which, in response to a command from the base unit or gate control unit, provides power to the gate operator (motor) to open and close the gate. The gate control unit includes both a call button for initiating voice communication with the base unit and a keypad for entering a coded ID. Each of the three units includes an ultra low-power microprocessor which controls the functionality. The base unit and gate control unit each include a transceiver section with high efficiency and low power consumption, but with enough power output, for example +5, dbm, to reach reliably between premises and gate. The gate receiver unit includes a receiver for reception of RF command signals from either the base unit or the gate control unit, and may also have a transmitter for acknowledging receipt of such signals. In any case, the system of the invention provides for the following: the gate control unit microprocessor controls the transceiver section, disabling all current consumption until needed; all sections of the gate control unit are deactivated (do not consume power), other than the motion detector, until either the call button or a key on the keypad is pressed; when a key press is detected, the gate control unit microprocessor is activated, but the transceiver remains unpowered until it is required; if the key press is that of the call button, the gate control unit microprocessor receives power and sends a digital, coded signal, containing digital ID and power is provided to the transceiver; the signal is sent to the base unit transceiver in the premises; if the key press is of one of the keypad keys, the microprocessor receives power and decodes the ID (sequence of keys) entered; and if the code entered matches one of the stored codes, the transmitter is powered to send a coded signal to a wireless receiver of the gate receiver unit, causing the gate to open with no wires attached.

There are times when a user may need to add an additional gate control unit 20 (or more) to an existing wireless gate control and communication system, or the user may need to replace a damaged or defective unit. Control unit 20 often has a considerable amount of information stored therein, such as identification codes and the corresponding access information, which has to be copied manually from one gate control unit 20 to an additional or replacement gate control unit 20. In order to copy all of the information from one unit to another, the user much spend a significant amount of time extracting the information from the pre-exiting unit 20 (or getting the information from a written or recorded source) and then re-entering the information into the new or additional gate control unit 20. In order to save time, gate control unit 20 may be provided with a “clone” feature that used the existing infrastructure of the microprocessors and transceivers in each gate control unit 20 (both the pre-existing unit and the new unit) along with program which allows the transfer of such information from one unit to the other.

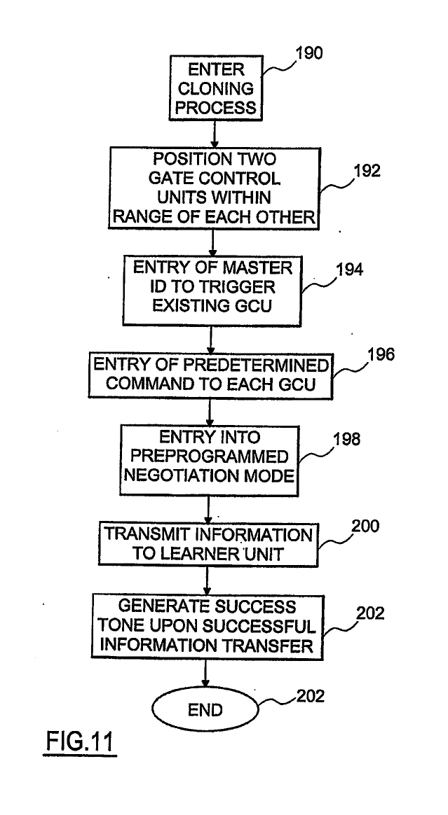

Referring to FIG. 11, cloning process 190 begins by positioning two gate control units 20 in range of each other 192. Existing gate control unit 20 is triggered by the entry of a master ID 194 by the user in order to assure that the information is not available to unwanted users, along with the entry of a predetermined command 196 into each unit 20 to configure them into clone mode. The entry of the master ID and command places the units into a preprogrammed negotiation mode 198, wherein the microprocessors communicate via the transceivers. The preexisting unit acts as a “teacher” and transmits the stored information to the “learner” unit 200.

The units may further be programmed to check parity or use any other conventional method for assuring that the information transfer was successful. For security, the units may also reduce their transmission power output during transmission step 200 in order to limit the range of the cloning session. In place of an RF transceiver, an IR transceiver may be used to send and receive the cloned data and communications. Once the data is successfully transferred, the units may be programmed to generate a success tone 202 to acknowledge the success of the cloning process to the user, thereby saving a significant amount of time for the user or installer by automatically transferring the stored information.

What is claimed is:

1. An apparatus comprising:
a base unit comprising:
a transceiver,
a user interface,
and a processing device operably connected to the transceiver and the user interface;
the base unit configured to:
be operated by a user in a secured area,
periodically check for wireless signals from a gate control unit,
in response to receiving a signal that a gate open button is pressed, send a wireless command to a gate receiver unit separate from the gate control unit to effect opening a barrier for the secured area, and
in response to receiving a wireless signal from the gate control unit, activate a talk process to effect wireless voice communications between the base unit and the gate control unit.

2. The apparatus of claim 1 wherein the base unit further comprises a codec, speaker, and microphone, and the base unit is configured to power down its components until initiation of an event that requires power.

3. The apparatus of claim 1 wherein the base unit is configured to periodically check for wireless signals from the gate control unit by powering up the transceiver to receive the wireless signals at specified time intervals.

4. An apparatus comprising:
a gate control unit comprising:
a transceiver,
a user interface configured to provide interaction with a person located outside of a secured area,
and a processing device operably connected to the transceiver and the user interface;
the gate control unit configured to:
power up in response to at least one of a keypress at the gate control unit or sensing motion near the gate control unit,
establish, in response to receiving a signal from the user interface to do so, wireless voice communications between the gate control unit and a base unit configured to be operated by a user located in the secured area in response to receiving a signal,
send, in response to receiving entry of a correct sequence of key presses on a keypad of the user interface, a wireless command to a gate receiver unit to effect opening a barrier for the secured area.

5. The apparatus of claim 4 wherein the gate control unit further comprises a codec, speaker, and microphone, and the gate control unit is configured to power down its components until initiation of an event that requires power.

6. A method comprising:
receiving user input through a user interface of a base unit in a secured area;
periodically checking a transceiver to receive wireless signals from a gate control unit disposed outside of the secured area;
in response to receiving a signal that a gate open button is pressed, sending a wireless command from the transceiver to a gate receiver unit separate from the gate control unit to effect opening a barrier for the secured area; and
in response to receiving a wireless signal from the gate control unit, activate a talk process to effect wireless voice communications between the base unit and the gate control unit.

7. The method of claim 6 further comprising powering down components of the base unit until initiation of an event that requires power.

8. The apparatus of claim 6 wherein the periodically checking comprises powering up the transceiver to receive the wireless signals at specified time intervals.

9. A method comprising:
powering up portions of a gate control unit located outside of a secure area in response to at least one of a keypress at a user interface of the gate control unit or sensing motion near the gate control unit;
establishing, in response to receiving a signal from the user interface to do so, wireless voice communications between the gate control unit and a base unit configured to be operated by a user located in the secured area in response to receiving a signal; and
sending, in response to receiving entry of a correct sequence of key presses on a keypad of the user interface, a wireless command to a gate receiver unit to effect opening a barrier for the secured area.

10. The method of claim 9 further comprising powering down components of the gate receiver unit until initiation of an event that requires power.
